(19) United States
(12) Patent Application Publication
(10) Pub. No.: US 2005/0175806 A1
(43) Pub. Date: Aug. 11, 2005

(54) Adhesive tape

(76) Inventor: John P Banovetz, Minneapolis, MN (US)

Correspondence Address: 3M INNOVATIVE PROPERTIES COMPANY, PO BOX 33427, ST. PAUL, MN, 55133-3427, US

(21) Appl. No.: 10/509,588

(22) PCT Filed: May 28, 2002
(86) PCT No.: PCT/US02/16666

(51) Int. Cl. B32B 9/00

(52) U.S. Cl. 428/40.1; 428/141

(57) ABSTRACT

The present invention relates to an adhesive tape comprising at least one layer of a radiation curable precursor of an adhesive and at least one film having two essentially oppositely parallel surfaces wherein at least one of said surfaces which is in contact with said radiation curable precursor, comprises a series of recesses therein and can be removed from said optionally partially cured precursor, and wherein said radiation curable precursor exhibits a loss tangent of at least 1 at a temperature of 50° C.

### FIELD OF THE INVENTION

The present invention relates to an adhesive tape comprising a layer of a radiation-curable precursor of an adhesive, said precursor having a loss tangent or tangent of phase angle delta (□) of at least 1 at a temperature of 50° C.

### BACKGROUND OF THE INVENTION

Precursors of radiation-cured adhesives are described, for example, in WO 96/14,349, WO 93/15,125, EP 1,026,218, EP 0,620,259, WO 98/38,262, U.S. Pat. No. 5,721,299, U.S. Pat. No. 6,136,384 or U.S. Pat. No. 6,153,302.

It is known that the performance of a bond between a radiation-cured adhesive and a substrate is influenced by the flow behaviour of the radiation-curable precursor of such adhesive on said substrate.

The flow behaviour of a radiation-curable precursor of a radiation-curable adhesive can be quantitatively described by referring to the viscoelastic properties and, in particular, to the loss tangent of such precursor. The loss tangent is defined as the tangent of the phase angle delta (□) with delta being the ratio of the loss modulus G″ over the storage modulus G′

$$δ = \frac{{G}^{″}}{{G}^{′}}$$

When applying an external strain to the radiation-curable precursor, the storage modulus G′ gives the elastic response of the precursor which is in phase with the external strain whereas the loss modulus G″ describes the unelastic response of the precursor which is out of phase with the external strain. Further details on the viscoelastic properties of polymers such as the radiation-curable precursors and adhesives and the measurement of such properties can be taken, for example, from Aklonis and MacKnight, “Introduction to polymer viscosity”, 2^{nd} ed., John Wiley & Sons, 1983.

The flow behaviour of the radiation-curable precursor can furthermore be characterized in terms of its so-called flow resistance which is a quantitative measure of its flow properties at a specified temperature. A method for measuring the flow resistance is described in the test section below.

While adhesives the radiation-curable precursors of which exhibit a macroscopic flow at the application temperature, tend to exhibit upon curing a favourable bonding performance, the handling of such precursors is adversely affected by such flowability.

It was therefore an object of the present invention to provide an adhesive tape comprising a precursor of a radiation-curable adhesive, said tape exhibiting an improved handleability and upon its application to a substrate, a favourable performance of the bonding between the radiation-cured adhesive and the substrate.

Other objects of the present invention can be taken from the following detailed description.

### BRIEF DESCRIPTION OF THE INVENTION

The present invention relates to an adhesive tape comprising at least one layer of a radiation-curable precursor of an adhesive and at least one film having two essentially parallel surfaces wherein at least one of said surfaces which is in contact with said radiation-curable precursor, comprises a series of recesses therein and can be removed from said optionally partially cured precursor, and wherein said radiation-curable precursor exhibits a loss tangent of at least 1 at a temperature of 50° C.

The present invention furthermore relates to the adhesive tape of the present invention wound up in the form of a roll.

The present invention furthermore relates to a method of applying the adhesive tape of the invention to a substrate, said method comprising the steps of applying the optionally partially cured radiation-curable precursor to said substrate and subsequently curing said precursor.

The present invention furthermore relates to a dimensionally secured layer of a flowable material having a loss tangent of at least 1 at a temperature of 50° C. and being in contact with at least one surface of a film having two essentially parallel surfaces wherein said at least one surface comprises a series of recesses therein and can be removed from said flowable material.

### BRIEF DESCRIPTION OF THE FIGURES

FIG. 1a shows a preferred embodiment of a film 1 useful in the present invention wherein said film comprises a first surface 2a and a second surface 2b. The first surface 2a comprises projections 3 and recesses 4 whereas the second surface 2b is essentially flat. The center line 5 of the first surface 2a is essentially parallel to the second surface 2b.

FIG. 1b shows a preferred embodiment of a film 1 useful in the present invention wherein said film comprises a first surface 2a and a second surface 2b. Both the first surface 2a and the second surface 2b comprise projections 3,3′ and recesses 4,4′ and the center lines 5,5′ are essentially parallel to each other.

FIG. 2a shows a preferred embodiment of an adhesive tape 10 according to the present invention comprising a layer 6 of a radiation-curable precursor of an adhesive which is in contact with the surface 2a of film 1 shown in FIG. 1a. The layer 6 of the radiation-curable precursor is covered by release liner 7.

FIG. 2b shows another preferred embodiment of an adhesive tape 10 comprising a layer 6 of a radiation-curable precursor which is in contact on each of its surfaces with a film 1, 1′. The layer 6 of the radiation-curable precursor comprises embedded therein a layer 8 of a non-woven material. The films 1, 1′ each comprise a surface 2a, 2a′ comprising projections 3, 3′, recesses 4, 4′ and center lines 5, 5′, and essentially flat surfaces 2b, 2b′. The center lines 5, 5′ are essentially parallel to each other.

FIG. 2c shows another preferred embodiment of an adhesive tape 10 of the present invention comprising two layers 6, 6′ of radiation-curable precursors of adhesive and the film 1 shown in FIG. 1b. The surface of layer 6 is covered by release liner 7, and layer 6′ comprises embedded therein a layer 8 of a non-woven material.

FIG. 2d shows another preferred embodiment of an adhesive tape 10 of the present invention comprising layer 6 of a radiation-curable precursor of an adhesive. One surface of such layer 6 is in contact with the surface 2a of the film 1 shown in FIG. 1a whereas the opposite surface of layer 6 is in contact with carrier layer 11 bearing a pressure-sensitive adhesive layer 8 which is covered by release liner 7.

### DETAILED DESCRIPTION OF THE INVENTION

The term radiation-curable precursor of an adhesive as used above and below refers to a material which upon curing by radiation, can be polymerized to an adhesive capable of bonding, for example, two substrates to each other. The precursor can be uncured or partially cured so that a multiplicity of precursors exists for a specific cured adhesive. The precursors may or may not exhibit adhesive properties but form an adhesive upon curing.

The term adhesive as used above and below is to be construed broadly and includes both pressure-sensitive adhesives and non-pressure-sensitive adhesives.

The term radiation as used above and below includes any actinic radiation such as, for example, electromagnetic radiation in the UV or visible range of the electromagnetic spectrum, and E-beam radiation.

The term macroscopic flow as such used above and below refers to materials which when subjected to method 1 of the two methods for measuring the flow resistance exhibit a change in the diameter of the test coupon of at least 1%.

The term embedding of non-woven material in the radiation-curable precursor of an adhesive as used above and below means that the non-woven material is incorporated into the precursor so that the radiation-curable precursor is essentially fully covered by and saturated with the precursor.

The radiation-curable precursor of an adhesive as useful in the present invention comprises
(i) at least one radiation-curable compound,
(ii) an effective amount of a photoinitiator when needed to initiate the curing and exhibits
(iii) a loss tangent of at least 1 at a temperature of 50° C.
   Radiation-curable compounds which are suitable in the present invention include organic compounds having at least one oxirane ring of the formula 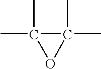
   polymerizable by a ring opening reaction.

Such materials, broadly called epoxides, include both monomeric and polymeric epoxides and can be aliphatic, alicyclic, heterocyclic, cycloaliphatic, or aromatic and can be combinations thereof. They can be liquid or solid or blends thereof, blends being useful in providing tacky radiation-curable precursors. These materials generally have, on the average, at least two epoxy groups per molecule and are also called “polyepoxides.” The polymeric epoxides include linear polymers having terminal epoxy groups (for example, a diglycidyl ether of a polyoxyalkylene glycol), polymers having skeletal oxirane units (for example, polybutadiene polyepoxide), and polymers having pendent epoxy groups (for example, a glycidyl methacrylate polymer or copolymer). The molecular weight of the epoxy resin may vary from about 74 to about 100,000 or more. Mixtures of various epoxy resins can also be used in the radiation-curable precursors of the invention. The “average” number of epoxy groups per molecule is defined as the number of epoxy groups in the epoxy resin divided by the total number of epoxy molecules present.

Useful epoxy resins include those which contain cyclohexene oxide groups such as the epoxycyclohexane carboxylates, typified by 3,4-epoxycyclohexylmethyl-3,4-epoxycyclohexane carboxylate, 3,4-epoxy-2-methylcyclohexylmethyl-3,4-epoxy-2-methycyclohexanecarboxylate, and bis(3,4-epoxy-6-methylcyclohexylmethyl) adipate. For a more detailed list of useful epoxides of this nature, reference may be made to U.S. Pat. No. 3,117,099, incorporated herein by reference.

Further epoxy resins which are particularly useful in the practice of this invention include glycidyl ether monomers of the formula: 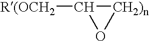
where R′ is aliphatic, for example, alkyl, aromatic, for example, aryl, or combinations thereof, and n is an integer of 1 to 6. Examples are the glycidyl ethers of polyhydric phenols obtained by reacting a polyhydric phenol with an excess of chlorohydrin such as epichlorohydrin, for example, the diglycidyl ether of 2,2-bis-(4-hydroxyphenol) propane (Bisphenol A). Further examples of epoxides of this type which can be used in the practice of this invention are described in U.S. Pat. No. 3,018,262, incorporated herein by reference. Preferred epoxy resins include diglycidyl ethers of Bisphenol A and hydrogenated bisphenol A-epichlorohydrin based epoxy resins.

There is a host of commercially available epoxy resins which can be used in the radiation-curable precursors of an adhesive according to this invention. In particular, epoxides which are readily available include octadecylene oxide, epichlorohydrin, styrene oxide, vinylcyclohexene oxide, glycidol, glycidyl methacrylate, diglycidyl ether of Bisphenol A (for example, those available under the trade designations “EPON 828” “EPON 1004”, and “EPON 1001F” from Shell Chemical Co., and “D.E.R. 332” and “D.E.R. 334”, from Dow Chemical Co.), diglycidyl ether of Bisphenol F (for example, those under the trade designations “ARALDITE GY281” from Ciba-Geigy Corp., and “EPON 862” from Shell Chemical Co.), vinylcyclohexane dioxide (for example, having the trade designation “ERL-4206” from Union Carbide Corp.), 3,4-epoxycyclohexylmethyl-3,4-epoxycyclohexene carboxylate (for example, having the trade designation “ERL-4221” from Union Carbide Corp.), 2-(3,4-epoxycyclohexyl-5,5-Spiro-3,4-epoxy) cyclohexane-metadioxane (for example, having the trade designation “ERL-4234” from Union Carbide Corp.), bis(3,4-epoxycyclohexyl) adipate (for example, having the trade designation “ERL-4299” from Union Carbide Corp.), dipentene dioxide (for example, having the trade designation “ERL-4269” from Union Carbide Corp.), epoxidized polybutadiene (for example, having the trade designation “OXIRON 2001” from FMC Corp.), 1,4-butanediol diglycidyl ether (for example, having the trade designation “ARALDITE RD-2” from Ciba-Geigy), hydrogenated bisphenol A-epichlorohydrin based epoxy resins (for example having the trade designation “EPONEX 1510” from Shell Chemical Co.), and polyglycidyl ether of phenol-formaldehyde novolak (for example, having the trade designation “D.E.N. 431” and “D.E.N. 438” from Dow Chemical Co.).

Curing of radiation curable precursors comprising at least one radiation-curable compound having at least one oxirane ring, is preferably effected by using one or more photoinitiators selected from a group of photoinitiators of two general types: onium salts and cationic organometallic salts, both described, for example, in U.S. Pat. No. 5,709,948, incorporated herein by reference.

Onium salt photoinitiators for cationic polymerizations include iodonium and sulfonium complex salts. Useful aromatic iodonium complex salts are of the general formula: 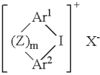
wherein
Ar¹ and A² can be the same or different and are aromatic groups having from 4 to about 20 carbon atoms, and are selected from the group consisting of phenyl, thienyl, furanyl, and pyrazolyl groups;
Z is selected from the group consisting of oxygen, sulfur, and a carbon-carbon bond, 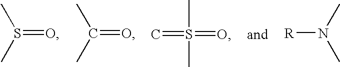
wherein R can be aryl (having from 6 to about 20 carbon atoms, such as phenyl) or acyl (having from 2 to about 20 carbon atoms, such as acetyl, or benzoyl), and 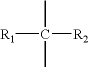
wherein R₁ and R₂ are selected from the group consisting of hydrogen, alkyl radicals having from 1 to about 4 carbon atoms, and alkenyl radicals having from 2 to about 4 carbon atoms;
m is zero or 1; and
X has the formula DQₙ wherein D is a metal from Groups IB to VIII or a metalloid from Groups IIIA to VA of the Periodic Chart of the Elements (Chemical Abstracts version), Q is a halogen atom, and n is an integer having a value of from 1 to 6. Preferably, the metals are copper, zinc, titanium, vanadium, chromium, magnesium, manganese, iron, cobalt, or nickel and the metalloids preferably are boron, aluminum, antimony, tin, arsenic and phosphorous. Preferably, the halogen, Q, is chlorine or fluorine. Illustrative of suitable anions are BF₄⁻, B (C₆F₅)₄⁻, PF₆⁻, SbF₆⁻, FeCl₄⁻, SnCl₅⁻, AsF₆⁻, SbF₅OH⁻, SbCl₆⁻, SbF₅⁻², AlF₅⁻², GaCl₄⁻, InF₄⁻, TiF₆⁻², ZrF₆⁻, CF₃SO₃⁻, and the like. Preferably, the anions are BF₄⁻, B (C₆F₅)₄⁻, PF₆⁻, SbF₆⁻, AsF₆⁻, SbF₅OH⁻, and SbCl₆⁻. More preferably, the anions are SbF₆⁻, AsF₆⁻, and SbF₅OH⁻.

The Ar₁ and Ar₂ aromatic groups may optionally comprise one or more fused benzo rings (for example, naphthyl, benzothienyl, dibenzothienyl, benzofuranyl, dibenzofuranyl, etc.). The aromatic groups may also be substituted, if desired, by one or more non-basic groups if they are essentially non-reactive with epoxide and hydroxyl functionalities.

Useful aromatic iodonium complex salts are described more fully in U.S. Pat. No. 4,256,828 which is incorporated herein by reference. The preferred aromatic iodonium complex salts are (Ar)₂I PF₆ and (Ar)₂I SbF₆.

The aromatic iodonium complex salts useful in the invention are photosensitive only in the ultraviolet region of the spectrum. However, they can be sensitized to the near ultraviolet and the visible range of the spectrum by sensitizers for known photolyzable organic halogen compounds. Illustrative sensitizers include colored aromatic polycyclic hydrocarbons, as described in U.S. Pat. No. 4,250,053, incorporated herein by reference. Suitable sensitizers should be chosen so as to not interfere appreciably with the cationic cure of the epoxy resin in the adhesive composition.

Aromatic sulfonium complex salt initiators suitable for use in the invention are of the general formula: 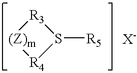
wherein
R₃, R₄ and R₅ can be the same or different, provided that at least one of the groups is aromatic. These groups can be selected from the group consisting of aromatic moieties having from 4 to about 20 carbon atoms (for example, substituted and unsubstituted phenyl, thienyl, and furanyl) and alkyl radicals having from 1 to about 20 carbon atoms. The term “alkyl” includes substituted alkyl radicals (for example, substituents such as halogen, hydroxy, alkoxy, and aryl). Preferably, R₃, R₄ and R₅ are each aromatic; and
Z, m, and X are all as defined above with regard to the iodonium complex salts.

If R₃, R₄ and R₅ is an aromatic group, it may optionally have one or more fused benzo rings (for example, naphthyl, benzothienyl, dibenzothienyl, benzofuranyl, dibenzofuranyl, etc.). The aromatic groups may also be substituted, if desired, by one or more non-basic groups if they are essentially non-reactive with epoxide and hydroxyl functionalities.

Triaryl-substituted salts such as triphenylsulfonium hexafluoroantimonate and p-(phenyl(thiophenyl) diphenylsulfonium hexafluoroantimonate are the preferred sulfonium salts. Useful sulfonium salts are described more fully in U.S. Pat. Nos. 5,256,828 and 4,173,476.

Aromatic sulfonium complex salts useful in the invention are typically photosensitive only in the ultraviolet region of the spectrum. However, they can be sensitized to the near ultraviolet and the visible range of the spectrum by a selected group of sensitizers such as described in U.S. Pat. Nos. 4,256,828 and 4,250,053.

If a sensitizer is used in combination with iodonium or sulfonium salts as described above, it should be chosen so as to not interfere appreciably with the cationic cure of the epoxy resin in the adhesive composition.

Suitable photoactivatable organometallic complex salts useful in the invention include those described in U.S. Pat. Nos. 5,059,701; 5,191,101; and 5,252,694, each of which is incorporated herein by reference. Such salts of organometallic cations have the general formula:
[(L¹)(L²)M^{m}]^{+e}X⁻
wherein
M^{m} represents a metal atom selected from elements of periodic groups IVB, VB, VIB, VIIB, and VIII, preferably Cr, MO, W, Mn, Re, Fe, and Co;
L¹ represents none, one, or two ligands contributing π-electrons that can be the same or different ligand selected from the group consisting of substituted and unsubstituted alicyclic and cyclic unsaturated compounds and groups and substituted and unsubstituted carbocyclic aromatic and heterocyclic aromatic compounds, each capable of contributing two to twelve π-electrons to the valence shell of the metal atom M. Preferably, L¹ is selected from the group consisting of substituted and unsubstituted η⁶-allyl, η⁵-cyclopentadienyl, η⁷-cycloheptatrienyl compounds, and η⁶-aromatic compounds selected from the group consisting of η⁶-benzene and substituted η⁶-benzene compounds (for example, xylenes) and compounds having 2 to 4 fused rings, each capable of contributing 3 to 8 π-electrons to the valence shell of M^{m};
L² represents none or 1 to 3 ligands contributing an even number of π-electrons that can be the same or different ligand selected from the group consisting of carbon monoxide, nitrosonium, triphenyl phosphine, triphenyl stibine and derivatives of phosphorous, arsenic and antimony, with the proviso that the total electronic charge contributed to M^{m} by L¹ and L² results in a net residual positive charge of e to the complex;
e is an integer having a value of 1 or 2, the residual charge of the complex cation; and
X is a halogen-containing complex anion, as described above.

Examples of suitable salts of organometallic complex cations useful as photoactivatable catalysts in the present invention include:
(η⁶-benzene)(η⁵-cyclopentadienyl)Fe⁺¹SbF₆⁻
(η⁶-toluene)(η⁵-cyclopentadienyl)Fe⁺¹ AsF₆⁻
(η⁶-xylene)(η⁵-cyclopentadienyl)Fe⁺¹ SbF₆⁻
(η⁶-cumene)(η⁵-cyclopentadienyl)Fe⁺¹ PF₆⁻
(η⁶-xylenes) (mixed isomers) (η⁵-cyclopentadienyl)Fe⁺¹ SbF₆⁻
(η⁶-xylenes) (mixed isomers) (η⁵-cyclopentadienyl)Fe⁺¹ PF₆⁻
(η⁶-o-xylene)(η⁵-cyclopentadienyl)Fe⁺¹ CF₃SO₃⁻
(η⁶-m-xylene)(η⁵-cyclopentadienyl)Fe⁺¹ BF₄⁻
(η⁶-mesitylene)(η⁵-cyclopentadienyl)Fe⁺¹ SbF₆⁻
(η⁶-hexamethylbenzene)(η⁵-cyclopentadienyl)Fe⁺¹ SbF₅OH⁻, and
(η⁶-fluorene)(η⁵-cyclopentadienyl)Fe⁺¹ SbF₆⁻.

Preferred salts of organometallic complex cations useful in the invention include one or more of the following: (η⁶-xylenes) (mixed isomers) (η⁵-cyclopentadienyl)Fe⁺¹ SbF₆⁻, (η⁶-xylenes) (mixed isomers) (η⁵-cyclopentadienyl)Fe⁺¹ PF₆⁻, (η⁶-xylene)(η⁵-cyclopentadienyl)Fe⁺¹ SbF₆⁻, and (η⁶-mesitylene)(η⁵-cyclopentadienyl)Fe⁺¹ SbF₆⁻.

Useful commercially available initiators include FX-512™ (Minnesota Mining and Manufacturing Company, St. Paul, Minn.), CD-1012™, and CD-101O™ (Sartomer, Exton, Pa.) aromatic sulfonium complex salts, UVI™-6974, an aromatic sulfonium complex salt (Union Carbide Corp., Danbury, Con.) and IRGACURE™ 261, a cationic organometallic complex salt (Ciba Geigy Chemicals, Hawthorne, N.Y.).

Radiation-curable compounds which are suitable in the present invention furthermore include organic compounds having at least one ethylenically unsaturated group of the formula 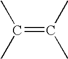
polymerizable by a radical polymerization reaction. Such materials include, for example, compounds comprising a vinyl-or a vinylene group and/or an (meth)acrylate group

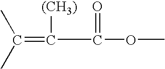

Curing of radiation-curable precursors comprising at least one radiation-curable compound having at least one ethylenically unsaturated group, is preferably effected by using one or more photoinitiators forming upon activation by actinic radiation or e-beam radiation one or more free radicals.

Preferred photoinitiators include benzoin ethers such as benzoin methyl ether of benzoin isopropyl ether, substituted benzoin ethers such as 2-methyl-2-hydroxylpropiophenone, aromatic sulfonyl chlorides such as 2-nathtalenesulfonyl chloride, and photoactive oxides such as 1-phenyl-1,1-propanedione-2-(o-ethoxy carbonyl)oxime. An example of a commercially available photoinitiator is Irgacure™ 651 available from Ciba-Geigy Corporation, having the formula 2,2-dimethoxy-1,2-diphenylethane-1-one.

The enumeration of radiation-curable compounds and photoinitiators suitable for curing such compounds is understood to be illustrative but not limiting.

The radiation-curable precursor of an adhesive useful in the present invention can comprise further adjuvants provided these do not adversely affect the radiation curing of the precursor to a high and/or practically unacceptable degree. Suitable adjuvants include, for example, non-polymerizable polymer additives such as ethylene-vinyl acetate copolymers acrylic polymers, polyesters, polyolefins, polyurethanes, fluoropolymers, rubber based polymers or reactive additives such as materials containing one or more hydroxyl groups. Suitable adjuvants furthermore include, e.g., plasticizers, pigments, fillers, stabilizers, antioxidants, colorants, binders, blowing agents, fungicides, bactericides, surfactants, glass and ceramic beads, flame retardants and other additives known to those skilled in the art.

Adjuvants and additives, if present, can be added in an amount to effect the intended purpose; typically, amounts of up to 30 wt. % with respect to the mass of the radiation-curable precursor can be used.

The radiation-curable precursor useful in the present invention exhibits a loss tangent at a temperature of 50° C. of at least 1, more preferably of at least 1.1 and especially preferably of at least 1.25. The loss tangent at a temperature of 50° C. preferably is between 1-10, more preferably between 1-7.5 and especially preferable between 1-5. The loss tangent is preferably measured according to the method specified in the test section below.

The radiation-curable precursors useful in the present invention preferably exhibit a macroscopic flow behaviour when applied to a substrate at room temperature. The flow behaviour of the radiation-curable precursors is preferably evaluated in terms of their flow resistance as is described in the test section below. Radiation-curable precursors of an adhesive which are suitable in the present invention, preferably exhibit a percentage change in the diameter of a sample of the radiation-curable precursor of at least 20%, preferred of at least 25% and especially preferred of at least 30% when measuring its flow resistance according to method 1 described in the test section below after 3 days at 23° C. using a 1 kg weight.

Because of their macroscopic flow behaviour, the radiation-curable precursors useful in the present invention tend to exhibit a favourable performance of the bonding provided by the cured adhesive, for example, between two substrates.

It was now found by the present inventors that the macroscopic flow of the radiation-curable precursors useful in the present invention can be controlled and considerably reduced when a layer of such radiation-curable precursor is in contact with at least one film having two essentially parallel surfaces wherein at least one of said surfaces which is in contact with the radiation-curable precursor, comprises a series of recesses therein. The terms “essentially parallel” and “recesses” as used above and below can be understood by considering a cross-section or surface profile of said film and defining a center line drawn through the structure of the respective surface profile such that the sum of the areas embraced by the surface profile above such center line is essentially equal to the sum of the areas below such center line. If one of the surfaces of the film does not exhibit a structure but is essentially flat, the center line of such surface essentially coincides with its surface. The term “essentially parallel” as used above and below means that the center lines of the two opposite major surfaces of the film are essentially parallel to each other. The term “recesses” as used above and below refers to the part of the surface profile of the film where the surface of the film is below said center line.

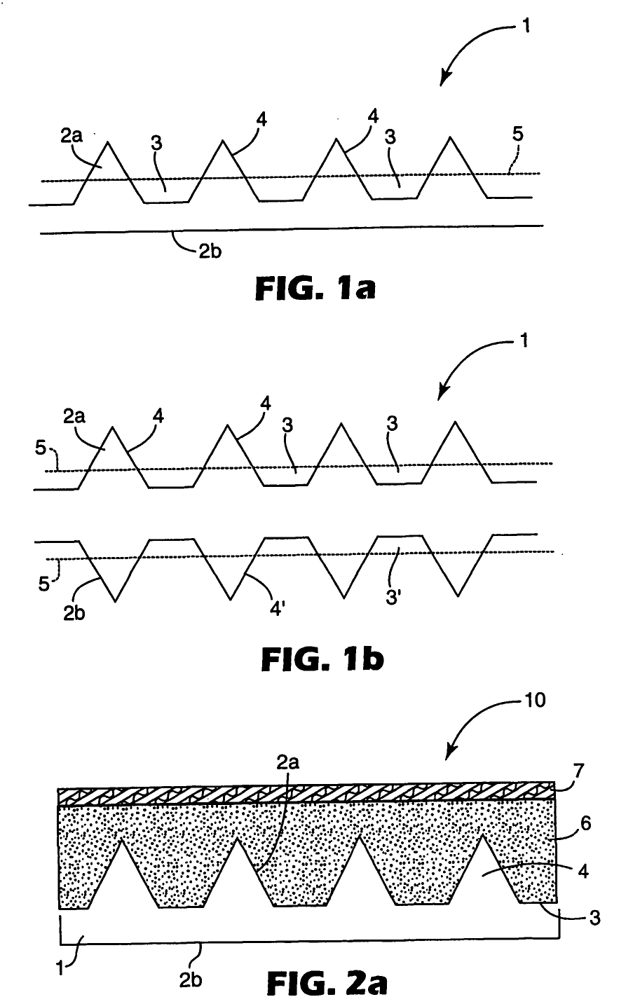

FIG. 1a shows the surface profile of a specific embodiment of a film 1 useful in the present invention wherein said film comprises a first surface 2a and a second surface 2b. The first surface comprises a structure through which the center line 5 is drawn, whereas the second surface is essentially flat. The center line 5 divides the surface profile into projections 3 and recesses or indentations 4. The center line 5 of surface 2a is essentially parallel to the surface of flat second surface 2b.

FIG. 1b shows the surface profile of another specific embodiment of a film 1 useful in the present invention wherein said film comprises a first surface 2a and a second surface 2b. Both the first surface 2a and the second surface 2b exhibit a surface structure through which center lines 5, 5′ are drawn defining projections 3, 3′ and recesses 4, 4′ on both surfaces 2a and 2b. The center lines 5 and 5′ are essentially parallel to each other.

FIGS. 1a and 1b are intended to illustrate the film 1 used in the present invention without being limiting in any way.

The recessions 4, 4′ may have any shape and their cross-sections may be, for example, convex, concave or otherwise curved, polygonal such as, e.g., triangular, trapezoid like in FIG. 1a and 1b, square, rectangular, W-shaped, or of irregular shape.

The depth of the recesses which is defined as the distance between the center line 5, 5′ and the deepest point of any recession 4, 4′, does not need to be uniform over the film but may vary from recession to recession; it is, for example, possible that the depth of the recessions varies, e.g., linearly over certain segments of the film profile so that the depth increases, e.g., from a maximum value to a minimum value over the extension of the segment whereby this variation is repeated in other segments of the film. This or other variations of the depth of the recesses can provide, e.g., a variation of the properties of the bond effected by applying and curing the radiation-curable precursor according to the present invention over the extension of the segments.

The average depth of the recessions preferably is between 15 and 200 μm, more preferably between 15 and 150 μm and especially preferably between 15 and 50 μm.

The recessions may form a regular pattern on the respective surface 2a, 2b of the film 1, or they may be arranged in a partly or completely irregular pattern. The number of recesses per surface unit preferably is between 1-10,000/cm², more preferably between 1-1,000/cm² and especially preferably between 1-100/cm².

The projections 3, 3′ may be of any shape and their cross-sections or profiles may be, for example, convex, concave or otherwise curved, polygonal such as, e.g., triangular like in FIGS. 1a and 1b, trapezoid, square, rectangular or of irregular shape.

In case the extensions of the individual projections 3, 3′ as measured from the center line 5, 5′ are different from each other, preferably at least 20% and more preferably at least 30% of the projections 3 exhibit the maximum value of the extensions so that the tape of a radiation-curable precursor of an adhesive can be wound up to form a stable roll.

The distribution and density of the projections 3, 3′ is correlated with the distribution and density of the recesses 4, 4′ so that the description given above for the recessions applies mutatis mutandis for the projections 3, 3′ as well.

The term “film” as used above and below includes all geometries having an extension in the X- and/or Y-direction which is large in comparison to the extension in Z-direction such as, for example, sheets, strips, ribbons or other geometries. Although the material used for the film is not critical to the invention, such material is preferably selected to be flexible so that the tape of a radiation-curable precursor of an adhesive can be wound up to form a stable roll. Films which are useful in the present invention may comprise, e.g., polymeric materials, metals, paper or combinations of these materials. Preferred are films comprising thermoplastic polymer materials used alone or as coating on a substrate film such as a paper, metal or another polymeric film. Especially preferred are films comprising a polymeric material selected from the group of materials consisting of polyethylene, polypropylene, polyolefin copolymers or blends of polyolefins such as, for example, a blend of polypropylene and LDPE (low density polyethylene) and/or LLDPE (linear low density polyethylene).

The structure comprising recesses 4, 4′ and projections 3, 3′ may be introduced into the film using various techniques such as, for example, mechanical embossing or moulding techniques. U.S. Pat. No. 4,576,850 discloses, for example, a process of forming a film comprising filling a master mould having a structure including projections and recesses to be replicated, with a curable precursor of the polymer with subsequent polymerization and recovering of the cured film. The cured film exhibits a structure complementary to that of the master mould. The master mould can be provided, for example, in the form of a rotary drum so that the process can be conducted continuously. It is also possible to introduce a thermoplastic polymer in its molten stage into the master mould with subsequent solidification and recovering of the polymer film. These techniques which are meant to be illustrative but by no means limiting, can be used to provide films having two essentially parallel surfaces wherein one surface is essentially smooth and exhibits no structure whereas the other surface exhibits a structure comprising one or more recesses as is illustrated, e.g., in the specific embodiment of FIG. 1a.

It is, however, also possible to provide films wherein both of the two essentially oppositely parallel surfaces exhibit a structure comprising one or more recesses as is illustrated, e.g., in the specific embodiment of FIG. 1b. Such structure can be obtained, e.g., by using two master rolls each having a structure comprising projections and recesses to be replicated, and arranging such master rolls so that they form a nip. A molten thermoplastic polymer can be introduced into said nip, and the resulting film exhibiting a structure on both surfaces 2a, 2b is solidified and recovered.

One or both of the surfaces 2a, 2b may optionally be release-coated in order to facilitate the removal of the radiation-curable precursors from at least one of the films the precursor is in contact with. Preferred are release coatings comprising one or more silicone based release materials such as those disclosed in Darrell Jones and Yolanda A. Peters, Silicone release coatings in Handbook of Pressure-Sensitive Adhesive Technology, ed. by Donatas Satas, 3^{rd} ed., 1999, Warwick, R.I., USA, pp. 652-683. Other suitable classes of release materials such as fluorocarbon copolymers and long side chain polymers are disclosed in Donatas Satas, Release Coatings, ebd., pp. 632-651. The release coatings, if present, preferably have a thickness of between 0.1 and 10 μm and more preferably of between 1 and 5 μm.

The radiation-curable precursors suitable in the present invention can be applied to one or both essentially oppositely parallel surfaces 2a, 2b of the film 1 comprising a series of recesses 4, 4′ by using various methods. In a preferred method the precursor is applied to said surface or surfaces of the film comprising a series of recesses by hot-melt coating whereby the film is subsequently wiped, e.g., with a doctor blade to provide a smooth exposed surface of the layer of the precursor. The precursor can also be applied by solvent coating or non-contact methods such as spray deposition wherein the adhesive is sprayed or deposited into the recesses individually.

The film having two essentially parallel surfaces 2a, 2b at least one of which comprising a series of recesses 4, 4′ and being in contact with a layer 6 of a radiation-curable precursor of an adhesive, is termed above and below as an adhesive tape.

It was surprisingly found that the surface or surfaces 2a, 2b of the film 1 having a series of recesses 4, 4′ therein, reduce the lateral flow of the radiation-curable precursor suitable in the present invention so that stable tapes are obtained which can be wound, for example, into the form of a roll. The average thickness of the layer 6 of the radiation-curable precursor as measured from the outside surface of such layer to the center line 5, can surprisingly exceed the sum of the average extension of the projections 3, 3′, and the average depth of the recesses 4, 4′ without resulting in unstable tapes. The ratio of the sum of the average extension of the projections 3, 3′ and the average depth of the recesses 4, 4′ to the average thickness of the layer 6 of the radiation-curable precursor of an adhesive preferably is at least 0.2, more preferably at least 0.5 and especially preferably at least 0.75.

The surface or surfaces 2a, 2b of the film 1 can each bear one single layer 6 of the radiation-curable precursor of an adhesive to provide a so-called transfer tape but multilayer structures are possible as well.

In one embodiment, at least one of the layers 6 of the radiation-curable precursor of an adhesive comprises embedded therein a non-woven material 8 which can be provided, for example, in the form of a continuous layer or of discontinuous segments, respectively. The ratio of the thickness of the non-woven material 8 to the thickness of the layer 6 of the radiation-curable adhesive preferably is 0.9 or less and more preferably 0.8 or less so that the non-woven material is preferably completely covered by and saturated with the radiation-curable precursor of the adhesive. Suitable materials for preparing continuous layers of non-woven materials include, for example, polyolefin, polyester and nylon. The addition of a non-woven material 8 to the layer 6 of the radiation-curable precursor tends to reduce the macroscopic flow of the radiation-curable precursor without adversely affecting the bond obtained upon curing the precursor to an inacceptable amount.

The thickness of layer 6 of the radiation-curable adhesive as measured between the outer surface of such layer and the center line 5 of the surface of film 1 it is in contact with, preferably is between 10 and 400, more preferably between 25 and 250 μm and especially preferably between 40 and 150 μm.

In another embodiment, at least one of the layers 6 of the radiation-curable precursor of an adhesive may bear, e.g., a carrier layer 11 which preferably extends over the whole length of the layer of the radiation-curable precursor of an adhesive but may also cover only part of it. Such backing may be manufactured from a wide range of materials such as polymer films or paper films. The backing preferably comprises materials which are selected from a group of polymeric materials consisting of polyvinylchloride, polyethylene terephthalate, polyolefins such as polyethylene or polypropylene, polyolefin copolymers or blends of polyolefins.

The thickness of the backing preferably is between 20 and 300 μm and more preferably between 30 and 150 μm.

The backing may bear further layers such as, for example, adhesive layers such as pressure-sensitive adhesive layers which may be applied by lamination or coating techniques.

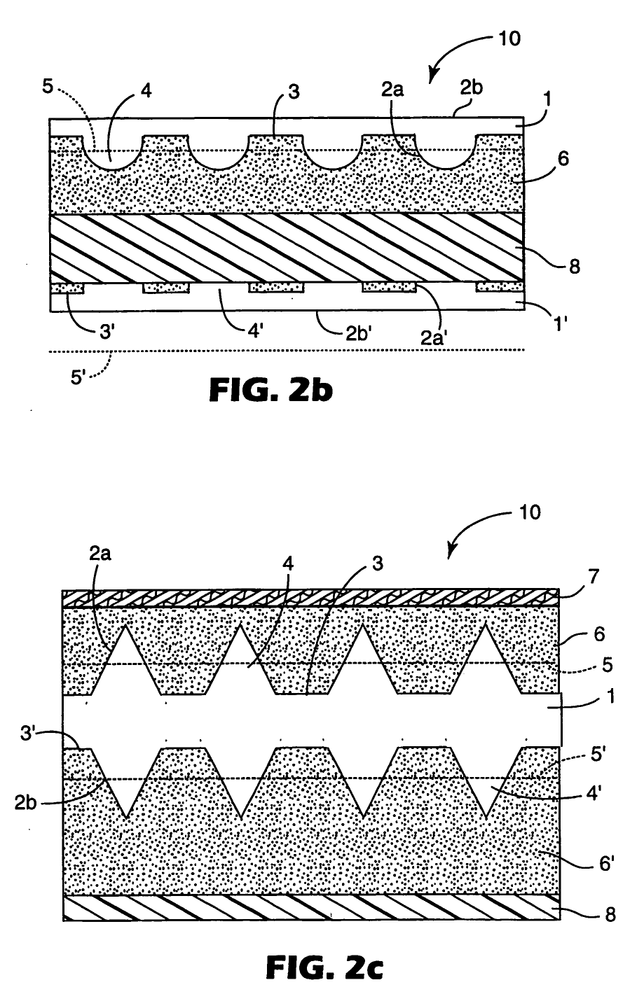

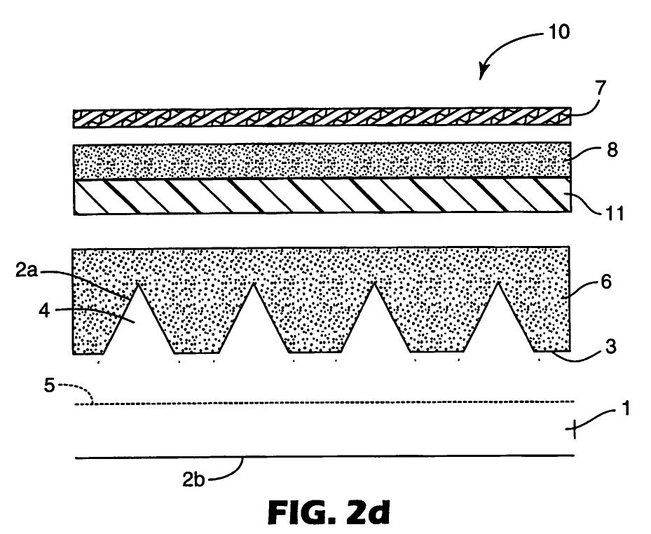

A preferred embodiment of an adhesive tape 10 of the present invention is shown in FIG. 2a. The adhesive tape 10 comprises a film 1 having a surface 2a exhibiting a structure of projections 3 and recesses 4, and an essentially flat surface 2b as is described in FIG. 1a above. The two surfaces 2a and 2b are essentially parallel to each other since the center line 5 of surface 2a is essentially parallel with respect to surface 2b. The surface 2a of the film 1 is in contact with a layer 6 of the radiation-curable precursor of an adhesive. It is schematically shown that the thickness of layer 6 of the radiation-curable precursor of an adhesive exceeds the sum of the average extension of the projections 3 and the average depth of the recessions 4. A release liner 7 may be placed on top of layer 6 of the radiation-curable precursor or an adhesive in order to protect layer 6 from contamination. The adhesive tape 10 of FIG. 2 may be wound up into a stable roll whereby the release liner 7 may be omitted if the surface 2b of the film 1 exhibits release properties with respect to the radiation-curable precursor of an adhesive and thus acts as a release surface.

Another preferred embodiment of an adhesive tape 10 of the present invention is shown in FIG. 2b. The adhesive tape 10 comprises a first and a second film 1, 1′ having inner surfaces 2a, 2a′ and outer surfaces 2b, 2b′, respectively. The inner surfaces 2a, 2a′ each comprise a structure of concavely shaped projections 3, 3′ and trapezoidal recessions 4, 4′ whereas the outer surfaces 2b, 2b′ are flat. The respective inner and outer surfaces of each film 1, 1 ′are essentially oppositely parallel to each other because the center lines 5, 5′ of the inner surfaces 2a, 2a′ of the two films 1, 1′ are essentially parallel with respect to the corresponding flat outer surfaces 2b, 2b′. Layer 6 of the radiation-curable precursor of an adhesive comprises embedded therein a layer 8 of a non-woven material.

It is schematically shown in FIG. 2b that the thickness of layer 6 of the radiation-curable precursor of an adhesive exceeds the sum of the average extensions of projections 3 and 3′ and the average depths of recessions 4 and 4′. The adhesive tape 10 of FIG. 2b may be wound up into a stable roll.

Another preferred embodiment of an adhesive tape of the present invention is shown in FIG. 2c. The adhesive tape 10 comprises a film 1 with two surfaces 2a and 2b each of which exhibits a structure of projections 3, 3′, and of recessions 4, 4′. The center lines 5, 5′ of the two surfaces 2a and 2b are essentially parallel to each other. The surfaces 2a and 2b, respectively, are in contact each with layers 6, 6′ of a radiation-curable precursor of an adhesive whereby such precursors and/or the thickness of the respective layers 6, 6′ may be equal to or different from each other. In the specific embodiment of FIG. 2c, layer 6′ comprises, for example, a layer of a non-woven material 8. When winding up the adhesive tape 10 of FIG. 2c into a stable roll, one release liner 7 is required. When unwinding the tape of FIG. 2c, the release liner is removed and adhesive layer 6 can be applied to a first substrate. Subsequently adhesive layer 6′ can be applied to another substrate, for example.

The specific embodiments of the adhesive tape 10 depicted in FIG. 2a-c are exemplary only and are intended to illustrate the invention without restricting it.

A specific example for an adhesive tape 10 of the present invention exhibiting a multilayer structure is shown in FIG. 2d. The layer 6 of the radiation-curable precursor of an adhesive is in contact with surface 2a of film 1 which exhibits a structure of triangle-shaped projections 3 and trapezoid recessions 4 as was shown in FIG. 1a. The other surface 2b of the film 1 is essentially flat and parallel to the center line 5 of surface 2a. The layer 6 of the radiation-curable precursor of an adhesive is in contact with carrier layer 11 which bears a layer 9 of a pressure-sensitive adhesive. If necessary, the layer 9 of the pressure-sensitive adhesive may be covered by a release liner 7.

The adhesive tapes 10 according to the present invention are preferably adhered to a substrate via an exposed surface of layer 6 of the radiation-curable precursor of an adhesive. The film 1 having two essentially parallel surfaces 2a, 2b, one of them being in contact with such layer 6, can be removed prior to applying the layer 6 to the surface of the substrate. It is, however, also possible that the layer 6 of the uncured precursor is applied to the surface of the substrate with the film 1 being still in contact with such layer 6. A release liner 7 optionally covering such layer 6 is removed prior to the application of layer 6 to the surface of the substrate. Due to its macroscopic flow properties, the radiation-curable precursor of an adhesive provides intimate contact between the layer 6 of the radiation-curable precursor of an adhesive of the adhesive tape 10 of the present invention and the surface of a substrate.

The adhesive tapes 10 can be applied to a wide variety of substrates including, e.g., substrates having a metal, paint, ceramic, glass, wooden or polymeric surface. Especially preferred substrates include, for example, metal, glass ceramic, pastics and combinations thereof, for example, bonding a metal substrate to a glass substrate.

Curing of the radiation-curable precursor of an adhesive can be effected after layer 6 of such precursor has been transferred to the surface of a first substrate whereby a liner if present has been removed prior to attaching layer 6 of the precursor to the first substrate. It may, however, also be desirable to partially cure the precursor with layer 6 of such precursor being still in contact with film 1, and to apply layer 6 of the partially cured radiation-curable adhesive subsequently to the surface of the substrate. Then a second substrate may be applied to layer 6 of the precursor to effect bonding of the two substrates. Which method is chosen depends on various factors including, for example, the flow properties of the uncured radiation-curable precursor, the surface properties of the first and second substrate and the transmittance of such substrates for the radiation used for curing.

Curing can be effected by using radiation sources emitting actinic radiation in the ultraviolet and also in the visible spectrum of the light (e.g., between about 200 to 800 nm). Suitable sources of radiation include mercury vapor discharge lamps, carbon arcs, tungsten lamps, xenon lamps, lasers, sunlight etc. Alternatively, radiation sources emitting electron beam radiation and gamma radiation can also be used. The required amount of exposure to effect polymerization is dependent upon various factors such as, for example, the nature and concentration of the radiation-curable chemical entities and the photoinitiators, the thickness of layer 6 of the radiation-curable precursor, the type of substrate, the power of the radiation source and the amount of heat associated with the radiation. These factors can, however, be controlled and adjusted by the person skilled in the art without any undue experimentation.

The methods of applying the adhesive tape 10 of the present invention described above are explanatory only and are intended to illustrate the invention without limiting it.

Although the present invention is particularly preferred for providing adhesive tapes comprising one or more layers of radiation-curable precursor of adhesive which are characterized by an advantageous flow behaviour, the teaching of the present invention can also be applied to other flowable materials exhibiting a macroscopic flow behaviour. Consequently, the present invention relates to a dimensionally secured layer of a flowable material having a loss tangent of at least 1 at a temperature of 50° C. and being in contact with at least one surface of a film having two essentially parallel surfaces wherein said at least one surface comprises a series of recesses therein and can be removed from said flowable material.

The present invention will be further illustrated by the Examples given below. Prior to this, some test methods are described which will be used in the Examples.

Test methods

Test Methods for the Radiation-Curable Precursor of an Adhesive

Flow Resistance of Radiation-Curable Precursors

Two methods are described below. Both measure the flow behaviour of the radiation-curable precursor of an adhesive.

Method 1

A 48-mm diameter circular coupon of a layer 6 of a radiation-curable precursor of an adhesive covered by both the film and the release liner in the Examples or by two release liners in the Comparative Examples, respectively, was placed onto a flat surface of a substrate.

A weight was placed on the coupon of the layer 6 of the radiation-curable adhesive for a specified length of time. Qualitatively, the flow of the radiation-curable precursor was determined by visual inspection. Weights employed and specific lengths of time employed for qualitative comparisons are cited in each Example or Comparative Example, respectively.

Quantitatively, the flow of the radiation-curable precursor was measured as a change in the diameter of the sample. Results are reported as a percentage change in the diameter of said coupon. Weights employed and specific lengths of time employed for quantitative comparisons are cited in each Example or Comparative Example, respectively.

Method 2

After preparation of an adhesive tape 10 comprising a layer of a radiation-curable precursor of an adhesive between a release liner 7 and a film 1 exhibiting a microstructured surface comprising recesses 4 and projections 3 and an essentially flat surface, as described in the examples, test samples of the layer of the radiation-curable adhesive were prepared by removing one of the release liner 7 or the film 1, respectively, from the layer of the radiation-curable precursor and laminating 25 mm length of said layer to a strip of aluminum foil (10 mm×16 mm×0.12 mm). Then the second of the release liner 7 and the film 1, respectively, was removed and the exposed surface of the layer 6 of the precursor of a radiation-curable adhesive was laminated to a stainless steel panel under 1 kg pressure.

The sample was then hung vertically and a 250-g weight attached. The time necessary for the weight to drop was then recorded. Longer failure times indicate a higher resistance to cold flow and indicate higher cohesive strength of the radiation-curable precursor of an adhesive.

Results are reported in minutes and represent the average bond failure times for at least two samples.

Loss Tangent of Radiation-Curable Precursor

Loss tangent measurements were completed on Rheometrics RDAII (S/N 29428207) using 25 mm parallel plates and a 200 g transducer. A temperature ramp from 100° C. to 25° C. at 5° C./min and 10% strain was performed. The autotension was off and the autostrain was used with the following parameters: Maximum applied strain=500,000%, maximum allowed torque=140 gm, Min allowed torque=0.5 gm, Strain adjustment set at 50% of current strain.

Test Methods for UV-Cured Adhesive Layer Bonded Between Two Substrates

Overlap Shear

Aluminum substrates (75 mm×25 mm×1 mm) were lightly abraded with a Scotchbrite™ 7447 scrubbing pad (available from 3M) and washed with isopropanol. Glass substrates (100 mm×25 mm×5 mm) were wiped clean of dust and used as received. After preparation of an adhesive tape 10 comprising a layer 6 of a radiation-curable precursor of an adhesive between a release liner 7 and a film 1 exhibiting a microstructured surface comprising recesses 4 and projections 3 and an essentially flat surface, test samples of the layer 6 of the radiation-curable precursor were prepared by removing one of the release liner 7 and the film 1, respectively, from a 1.27 cm×2.5 cm sample of the adhesive tape 10 and laminating the sample of the layer 6 of the precursor to the aluminum substrate with finger pressure.

The second of the release liner 7 and the film 1, respectively, was then removed. In the cases of aluminum-aluminum overlap shear measurements, the exposed face of the radiation-curable precursor was then irradiated with 1100-2000 mJ/cm² of UV-A radiation emitted from a hand-held lamp available as UVAHAND™ 250 lamp from Dr. Hoenle GmbH (Planegg, Germany). Immediately after the UV irradiation process, the second aluminum was applied to the exposed surface of the partially cured precursor under finger pressure. In the case of aluminum-glass or glass-glass overlap shear measurements, the glass substrate was laminated to the exposed surface of the layer of the radiation-curable precursor with finger pressure prior to irradiation. The resulting aluminum-glass or glass-glass assembly of substrates, respectively, was then exposed to 1,800-2,100 mJ/cm² UV-A radiation emitted from a hand held lamp available as UVAHAND™ 250 lamp from Dr. Hoenle GmbH (Planegg, Germany). The amount of energy used to irradiate the adhesive face was measured using a UVI Map™ UV and Temperature Measuring/Plotting System, Model UM365H-S (Electronic Instrumentation Technology Inc., Sterling Va., USA) designed to measure UV-A radiation in the range of 320-390 nm.

The bonded assemblies were tested after at least three days at 23° C. Measurements were completed according to Test Method ISO 4587 using a 5-mm/min test speed. Glass-glass measurements were completed in compression as opposed to elongation mode. Reported values are the average of at least three samples and are reported in MPa unless otherwise noted.

Kataplasma Test

Samples of adhesive tapes 10 as prepared in the examples were used to bond aluminum substrates to glass substrates. Application of the layer of the radiation-curable precursor of an adhesive to one of the samples with subsequent application of the other substrate and curing was performed as described in the Overlap Shear Test section above.

The bonded assemblies comprising two substrates bonded by a radiation-cured adhesive layer were immersed in 70° C. water for 7 days. Immediately following removal from the water, assemblies in which the bond remained intact were cooled to 40° C. for 2 hours. The assemblies were then removed from the freezer and warmed to 23° C.

Assemblies in which the bond remained intact were classified as having passed the test. The samples that passed this test were then conditioned and subjected to further testing comprising overlap shear measurements by the method described above. Assemblies in which the bond had broken after water immersion and low temperature, were classified as having failed the test and were not subjected to further testing.

Materials Employed in the Examples

A. Polyester Resins

Dynapol™ S1313 polyester, Tg=13° C., available from Huels AG (Creanova Specialties) Marl, Germany
Dynapol™ S1359 polyester, Tg=−16° C., available from Huels AG (Creanova Specialties) Marl, Germany
   B. Epoxy Resins
D.E.N.™ 438 epoxy,—high viscosity novolac epoxy available from Dow Chemicals Co., Midland Mich., USA
D.E.R.™ 331 epoxy, bisphenol A based epoxy available from Dow Chemicals Co., Midland Mich., USA
Epon™ 1001 epoxy—solid epoxy commercially available from Shell Chemical
   C. Other Additives
Voranol™ CP755 polyol—polyether triol available from Dow Chemical Co. Midland Mich., USA
Aerosil™ R972 fumed silica particles available from Degussa-Huels AG, Frankfurt, Germany
EXL™ 2314,—based core shell toughener available from Rohm and Haas Co., Philadelphia, Pa., USA
CYRACURE™ UVI 6974, triarylsulfonium complex salt available from Union Carbide, Danbury, Conn., USA
A-187™ organofunctional silane available from Union Carbide, Danbury Conn., USA
   D. Non-Woven Scrims
Cerex™, nylon non-woven, average thickness of 68 □m, available from Cerex Co, Cantonment, Fla., USA
Reemay™ 2004, polyester non-woven, average thickness of 79 μm, available from BBA Co.
Pegatex™, polypropylene non-woven, average thickness of 203 μm, available from Pegas Co. Czechoslovakia

### EXAMPLES

### Example 1

12.5 grams of Dynapol™ S 1359, 6.4 grams of D.E.N.™ 438 epoxy, 25.5 grams of Epon™ 1001 epoxy, and 10.0 grams of Voranol™ CP755 were combined in a glass container and placed in a forced air oven for 2 hours at 140° C. The resulting mixture was stirred periodically by hand until homogeneous. 2.3 grams of Aerosil™ R972 were then blended into the mixture by hand. 0.5 grams CYRACURE™ UVI 6974 and 0.5 grams A-187™ organofunctional silane was then added and the mixture stirred until homogenous.

The resulting liquid described above was then poured between a siliconized polyester (polyethlyeneterephthalate) release liner and a siliconized polyester film having one essentially flat surface and a microstructured surface exhibiting 125 lines per inch with square pyramidal projections and trapezoidal recesses having a sum of the depth of the recesses and the extensions of the projections of 25 microns. and its center line are essentially parallel to each other. The essentially flat surface of the film and its manufacture are disclosed in WO00/69,985. Both the release liner and the film had previously been threaded into a heated knife coater. Coating between the release liner and the film at 120° C. produced an adhesive tape comprising a pressure-sensitive adhesive layer of a radiation-curable precursor with a thickness of ca. 100 microns between the release liner and the microstructured film.

Cold flow analysis was conducted on the uncured layer of the precursor as is described in the test method section above (flow resistance of radiation-curable precursors, method 1). The sample of the uncured layer of the precursor was held between the release liner and the film for 2 hours at 120° C. under a 500 g weight applied to the surface of the release liner or the film, respectively. It was then qualitatively determined by visual inspection whether or not cold flow could be observed. The loss tangent for the radiation-curable precursor was measured at 50° C. according to the test method described above. Cured adhesive bonds between two substrates were also prepared and these were evaluated according to the Overlap Shear Test. Results are summarized in Table 1.

### Comparative Example 1

The radiation-curable polyester/epoxy precursor of an adhesive of Example 1 was poured between two siliconized polyester (polyethyleneterephthalate) release liners having in each case two essentially flat surfaces. The liners had been previously threaded into a heated knife coater. Coating at 120° C. produced an adhesive tape comprising a layer of the radiation-curable precursor with a thickness of ca. 100 microns between the two release liners. A sample of the adhesive covered by the two release liners, was subjected to the qualitative cold flow analysis test disclosed in Example 1.

### Comparative Example 2

Comparative Example 1 was repeated with the exception that an adhesive tape with a layer of a radiation-curable precursor of an adhesive having a thickness of ca. 400 microns was produced.

TABLE 1

| | | Cold Flow | Overlap Shear | Loss tangent |
|---|---|---|---|---|
| | | Analysis* | (MPa) | (50° C., |
| | Thickness | (Uncured | (Cured | uncured |
| Example | (μm) | precursor) | Adhesive) | presursor) |
| 1 | 100 | −− | 4.0 | 1.2 |
| Comp 1 | 100 | ++ | 6.8 | 1.2 |
| Comp 2 | 400 | ++ | 6.2 | 1.2 |

*Qualitative test conditions. The sample was held 2 hours at 120° C. under a 500 g weight
−− = No cold flow by visual inspection
++ = Cold flow was observable

The results in Table 1 show that the cold flow of the layer of the radiation-curable precursor under stress is limited while such layer is in contact with the surface of a film having a series of recesses therein. Curing of such layer still results in producing strong bonds.

### Example 2

Example 1 was repeated with the exception that another UV-curable adhesive composition was employed. 25 pph Dynapol™ S 1313 polyester, 10 pph D.E.N.™ 438 epoxy, 50 pph Epon™ 1001 epoxy and 15 pph Voranol™ CP755 were heated in a glass jar at 140° C. for 2 hours. The mixture was periodically blended by hand until homogeneous. 1 pph CYRACURE™ UVI 6974 and 1 pph A-187™ organofunctional silane (both amounts relative to the polyester/epoxy composition) were added and mixed until dissolved.

### Examples 3-5

The radiation-curable precursor of an adhesive of Example 2 was employed in preparation of adhesive tapes according to the invention comprising a non-woven web material embedded in the layer of the radiation-curable precursor.

A heated knife coater was threaded with two siliconized polyester films 1, 1′ each comprising an essentially flat surface 2b, 2b′ and a microstructured surface 2a, 2a′ exhibiting 50 lines per inch with square pyramidal projections 3 and trapezoid recesses 4 wherein the sum of the depth of the recesses 4 and the extension of the projections 3 is 25 μm. The essentially flat surface 2b of the film and its center line 5 are essentially parallel to each other. The film and its manufacture are disclosed in WO 00/69,985. The non-woven web material 8 was then placed between the microstructured films such that the microstructured surfaces faced the non-woven web material. The heated radiation-curable precursor of Example 2 was poured between one of the films and the non-woven material. Coating at 120° C. through the knife coater pressed the radiation-curable polyester/epoxy precursor into the non-woven web 8 and produced a layer 6 of the radiation-curable precursor having a thickness of about 100 μm greater then the thickness of the non-woven web.

The constructions of the adhesive tapes of Example 2-5 as well as the test results on both uncured and cured layer of the radiation-curable precursor are summarized in Table 2.

### Comparative Examples 2-5

The composition of the radiation-curable precursor of Example 2 was coated as described in Examples 2-5 with the exception that siliconized polyester (polyethyleneterephthalate) release liners 7 comprising two essentially flat and oppositely parallel surfaces were used instead of the microstructured films 1.

As before, coating at 120° C. through the knife coater pressed the polyester/epoxy adhesive into the non-woven web 8 and produced a layer 6 of a radiation-curable precursor with a thickness ca. 100 microns greater then the thickness of the non-woven web material.

TABLE 2

| | | | Uncured Precursor | | | | |
|---|---|---|---|---|---|---|---|
| | | | Flow | | | | |
| | | | Test¹⁾, | Flow | | Cured Adhesive | |
| | Adh. Tape Construction | | Final | test¹⁾ | Loss | Overlap | |
| | Microstruct. | Non- | diameter | (% | tangent | shear test²⁾, | Kataplasma |
| Ex. | films | woven | (mm) | change) | (50° C.) | (MPa) | test³⁾ |
| 2 | Yes | None | 28 | 12 | 1.5 | 8.4 | Pass (2.0) |
| 3 | Yes | CEREX | 29 | 16 | 1.5 | 6.9 | Pass (6.0) |
| 4 | Yes | REEMAY | 27 | 8 | 1.5 | 9.0 | Pass (5.4) |
| | | 2004 | | | | | |
| 5 | Yes | PEGATE X | 26 | 4 | 1.5 | 8.4 | Pass (4.2) |
| C2 | No | None | 38 | 52 | 1.5 | — | — |
| C3 | No | CEREX | 38 | 52 | 1.5 | — | — |
| C4 | No | REEMAY | 31 | 24 | 1.5 | — | — |
| | | 2004 | | | | | |
| C5 | No | PEGATE X | 32 | 28 | 1.5 | — | — |

¹⁾Initial sample diameter of the layer of the radiation-curable precursor was 25 mm. Samples were evaluated after 3 days at 23° C. using a 1 kg weight
²⁾Overlap shear measurements were completed with glass/glass bonds
³⁾Cured adhesive bond between aluminum and glass substrates
— Not tested

The results shown in Table 2 demonstrate that the use of two films 1 having each a microstructured surface, reduces cold flow of the layer 6 of the radiation-curable precursor, including those layers comprising non-woven web materials as scrims. The results summarized in Table 2 also show that the presence of the non-woven web material does not adversely effect the cohesive strength of the cured adhesive bond if the non-woven web material has been completely covered by and fully saturated with the radiation-curable precursor of an adhesive prior to curing.

### Examples 6-9

The procedure of Examples 3-5 was repeated whereby Pegatex™ non-woven web material having a thickness of 203 μm was used. The coating gap was adjusted to provide different thicknesses of the layer of radiation-curable adhesive in which the non-woven web material was embedded. The thickness of the layer of the radiation-curable precursor and the test results from Examples 6-9 are summarized in Table 3. Uncured precursor samples were tested for their flow properties and the cured adhesive was tested for its overlap shear strength in glass-to-glass bonds.

TABLE 3

| | Thickness¹⁾ | Uncured precursor | | |
|---|---|---|---|---|
| | of the | Flow test²⁾, | | Cured adhesive |
| | precursor | final diameter | Flow test²⁾ | Overlap shear³⁾ |
| Example | layer (μm) | (mm) | (% change) | (MPa) |
| 6 | 240 | 25 | 0 | 4.47 |
| 7 | 300 | 26 | 4 | 8.42 |
| 8 | 375 | 26 | 4 | 7.43 |
| 9 | 540 | 29 | 12 | 8.11 |

¹⁾embedding the 203 μm thickness of non-woven web
²⁾Initial diameter of the sample of the radiation-curable precursor = 25 mm. Samples were evaluated after 3 days at room temperature using a 1 kg weight
³⁾Cured adhesive bond between two glass substrates

The results summarized in Table 3 indicate that as the thickness of the layer of the precursor increases, the flow of the precursor also increases. However, the cold flow remains relatively small, even for relatively thick samples of the precursor, so that the corresponding adhesive tapes of the invention are practical and useful in everyday applications.

When the thickness of the layer of the radiation-curable precursor is comparable to the combined thickness of the non-woven web and the sum of the extension of the recesses and projections, respectively, of the microstructured film surface, a decrease in the overlap shear strength of the cured adhesive is seen. However, once the thickness of the layer 6 of the radiation-curable precursor exceeds the combined thickness of the non-woven and the microstructured film features by at least 10%, consistent high bond strengths are achieved.

1-16. (canceled)

17. Adhesive tape comprising at least one layer of a radiation curable precursor of an adhesive and at least one film having two essentially parallel surfaces wherein at least one of said surfaces which is in contact with said radiation curable precursor, comprises a series of recesses therein and can be removed from said optionally partially cured precursor, and wherein said radiation curable precursor exhibits a loss tangent of at least 1 at a temperature of 50° C.

18. Adhesive tape according to claim 17 wherein said adhesive exhibits a loss tangent of between 1-10 at 50° C.

19. Adhesive tape according to claim 17 wherein the radiation curable precursor comprises one or more radiation curable polymer materials, optionally one or more non-radiation curable polymer materials and an effective amount of a photoinitiator.

20. Adhesive tape according to claim 19 wherein the radiation curable polymer materials are selected from a group comprising epoxy containing polymer materials and/or polymer materials with unreacted vinyl groups and/or unreacted (meth)acrylate groups.

21. Adhesive tape according to claim 20 wherein the non-radiation curable polymer materials are selected from a group comprising polyolefins, polester, (meth)acrylate polymers, polyurethanes, fluoropolymers, ethylene-vinyl acetate polymers, rubber based polymers and blends of two or more of these polymer materials.

22. Adhesive tape according to claim 17 wherein the film comprises polymeric materials, metals, paper, non-woven materials or combinations of these materials.

23. Adhesive tape according to claim 17 wherein the recesses have a cross-sectional shape selected from polygonal or curved.

24. Adhesive tape according to claim 17 wherein the number of recesses is from 1-10,000/cm².

25. Adhesive tape according to claim 17 wherein the recesses form a pattern.

26. Adhesive tape according to claim 17 wherein the ratio of the sum of the average extension of the projections and the average depth of the recesses to the average of the radiation curable adhesive layer is at least 0.2.

27. Adhesive tape according to claim 17 wherein the radiation-curable adhesive layer is reinforced by a layer of a non-woven material.

28. Adhesive tape according to claim 27 wherein the ratio of the thickness of the reinforcing layer of the non-woven material to the thickness of the radiation-curable adhesive layer is from 0.1 to 0.9.

29. Adhesive tape according to claim 17 comprising a backing.

30. Adhesive tape according to claim 17 wherein the radiation-curable precursor is tacky.

31. Adhesive tape according to claim 17 wound up in the form of a roll.

32. Method of applying an adhesive tape according to claim 17 to a substrate comprising the steps of applying the optionally partially cured radiation curable precursor to said substrate and subsequently curing said precursor.
